(19) United States
(12) Patent Application Publication
(10) Pub. No.: US 2015/0224666 A1
(43) Pub. Date: Aug. 13, 2015

(54) DUST COLLECTOR AND CIRCULAR SAW HAVING A DUST COLLECTOR

(71) Applicant: REXON INDUSTRIAL CORP., LTD., Taichung (TW)

(72) Inventors: Ju Zhen LIN, Taichung (TW); Ya Pin KUO, Taichung (TW)

(73) Assignee: REXON INDUSTRIAL CORP., LTD., Taichung (TW)

(21) Appl. No.: 14/619,395

(22) Filed: Feb. 11, 2015

(30) Foreign Application Priority Data
Feb. 12, 2014 (TW) 103104598

(51) Int. Cl. B26D 7/18; B01D 46/00; B27G 3/00; B01D 46/02; B23D 45/04; B23D 59/00

(52) U.S. Cl. CPC B26D 7/1863; B23D 45/042; B23D 59/006; B27G 3/00; B01D 46/02; B01D 46/001

(57) ABSTRACT

A dust collector and a circular saw having a dust collector are disclosed. The dust collector includes a flexible bag having a connecting end, an opposing bottom end and an extending portion connected between the connecting end and the bottom end with an elastically deformable property for avoiding interference with the operation of the machine using the dust collector. The dust collector of the circular saw includes a suction hole located in a suspension arm of the circular saw and defining a bottom opening and an opposing top opening, and a dust collection unit including a flexible dust bag having a connecting end fastened to the top opening and an opposing bottom end disposed below the elevation of the top opening to prevent collected dust from reversely falling out of the dust bag.

### FIELD OF THE INVENTION

The present invention relates to circular saw technology and more particularly, to a circular saw and a dust collector for a circular saw.

### BACKGROUND

Referring to FIG. 1, a conventional circular saw is shown comprising a worktable 1, a suspension arm 2 disposed above the worktable 1, a saw blade 3 mounted at a distal end of the suspension arm 2, and a dust bag 4 mounted at the suspension arm 2. The suspension arm 2 comprises a mounting portion 201 connected to the worktable 1, a swinging portion 202 pivotally connected to the mounting portion 201 for supporting the saw blade 3, and a suction hole 203 located in one end of the swinging portion 202 of the suspension arm 2 adjacent to the mounting portion 201. The dust bag 4 is mounted at the suspension arm 2 to face toward the suction hole 203. Further, the suction hole 203 and the dust bag 4 extend in a direction tangential to the cutting edge of the saw blade 3. When the saw blade 3 is rotated to cut the workpiece, the dust thus produced will flow through the suction hole 203 in a tangential manner relative to the cutting edge of the saw blade 3, and then fall to the inside of the dust bag 4.

This dust collection measure has been widely used. However, because the dust bag 4 is shaped like a blade and the bottom end of the dust bag 4 is disposed above the elevation of the suction hole 203, when the operator biases the swinging portion 202 and the saw blade 3 upwards relative to the mounting portion 201 and then biases the swinging portion 202 and the saw blade 3 downwards relative to the mounting portion 201 during the cutting operation, as shown in FIG. 2, the dust that falls to the inside of the dust bag 4 can be induced to fall out of the suction hole 203, thus resulting in poor dust collection.

Further, the dust bag 4 has limited space for collecting dust. Thus, it is necessary to frequently shut down the machine and clean up the dust bag, which complicates the operation.

Moreover, if the length of the dust bag 4 is extended in order to increase the dust collection space, the dust bag 4 can interfere with the operation of the machine.

### SUMMARY OF THE INVENTION

The present invention has been accomplished under the circumstances in view. It is the main object of the present invention to provide a dust collector, which provides sufficient space for collecting dust, and is elastically deformable to avoid interference with the operation of the machine.

It is another object of the present invention to provide a dust collector in a circular saw, which prevents collected dust from reversely falling to the outside, facilitates dust collection over a long time, and is convenient to use.

To achieve these and other objects of the present invention, a dust collector comprises a dust bag. The dust bag is flexible, comprising a connecting end, an opposing bottom end, and an elastically deformable extending portion connected between the connecting end and the bottom end.

To achieve these and other objects of the present invention, a circular saw having a dust collector comprises a worktable, a suspension arm disposed above the worktable, a saw blade mounted at a distal end of the suspension arm, and a dust collector. The suspension arm comprises a mounting portion connected to the worktable, and a swinging portion pivotally connected to the mounting portion. The dust collector comprises a suction hole and a dust collection unit. The suction hole is located in one end of the swinging portion of the suspension arm adjacent to the mounting portion, defining a bottom opening that faces downwardly in a tangential manner relative to the cutting edge of the saw blade and an upward-facing top opening opposite to the downward-facing bottom opening. The dust collection unit is mounted at the suspension arm to face toward the suction hole, and comprises a flexible dust bag. The dust bag comprises a connecting end fastened to the top opening, and an opposing bottom end disposed below the elevation of the top opening.

The present invention achieves the following advantages and effects. The flexible characteristic of the dust bag of the dust collector prevents interference with the operation of the machine. Subject to the feature that the bottom end of the dust bag of the dust collection unit is disposed below the elevation of the top opening of the suction hole, the dust thrown away by the saw blade can be smoothly guided through the suction hole to the bottom end of the dust bag, and the collected dust can be prohibited from reversely falling out of the dust bag.

### BRIEF DESCRIPTION OF THE DRAWINGS

Other advantages and features of the present invention will be understood by reference to the following specification in conjunction with the accompanying drawings, in which like reference characters denote like elements of structure.

FIG. 1 is a side view of a circular saw equipped with a dust collector according to the prior art.

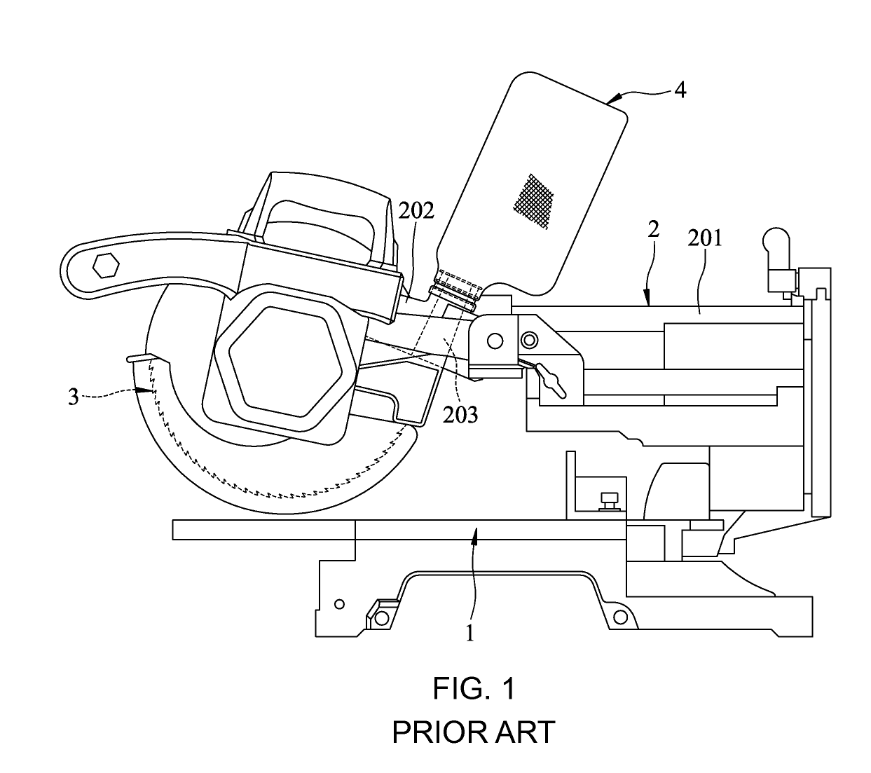

FIG. 2 is a side view illustrating a saw blade biasing status of the prior art circular saw shown in FIG. 1.

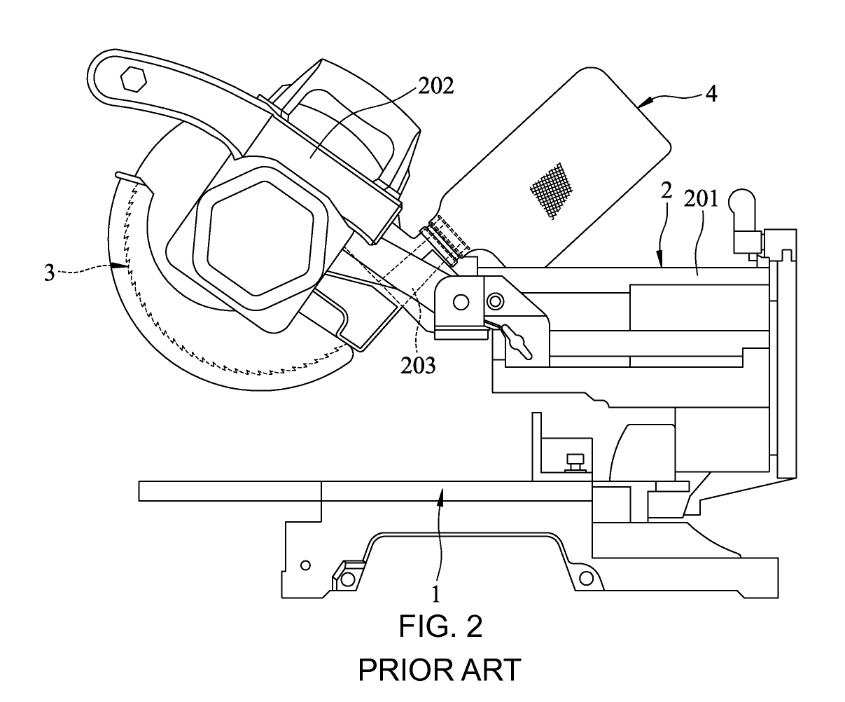

FIG. 3 is a side view of a circular saw having a dust collector in accordance with a first embodiment of the present invention.

FIG. 4 is a side view of the first embodiment of the present invention, illustrating a saw blade biasing status.

FIG. 5 is a sectional view of the first embodiment of the present invention, illustrating the arrangement of the dust bag and rigid support material of the dust collection unit of the dust collector.

FIG. 6 is a side view of a circular saw having a dust collector in accordance with a second embodiment of the present invention.

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary embodiments of the present invention and the components thereof, and in no way limits the structures, configurations and components thereof according to the present disclosure.

### DETAILED DESCRIPTION

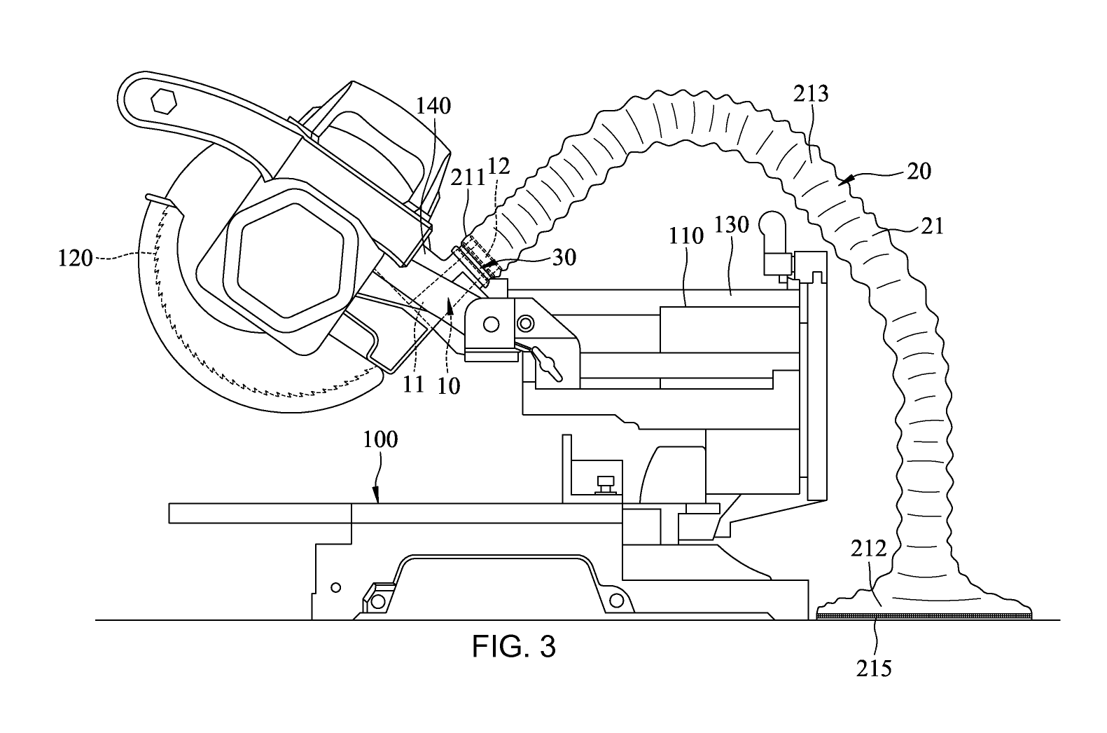

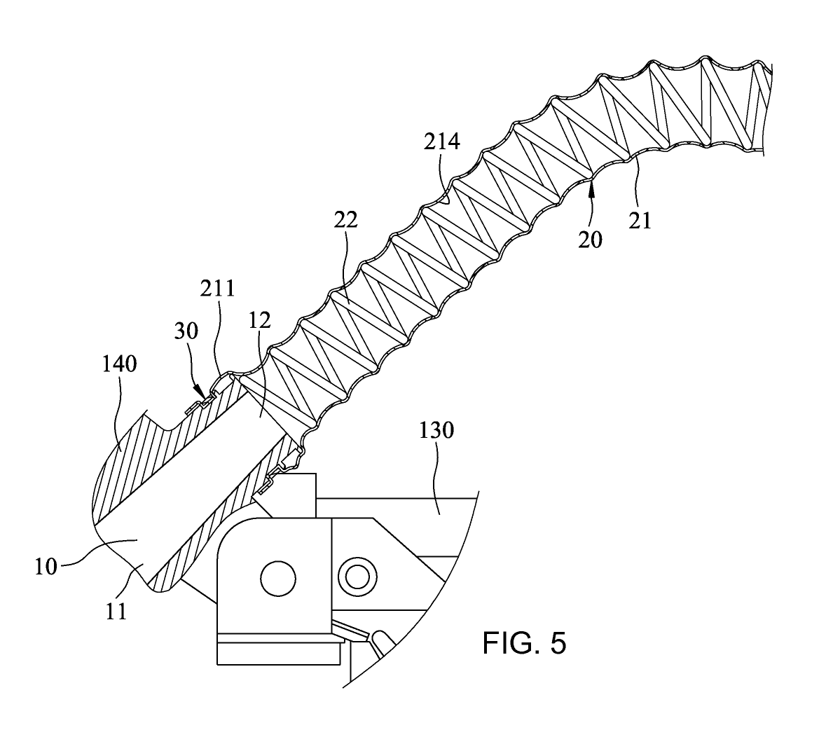

Referring to FIG. 3 and FIG. 5, a circular saw having a dust collector in accordance with a first embodiment of the present invention is shown. The circular saw comprises a worktable 100, a suspension arm 110 suspending above the worktable 100, and a saw blade 120 mounted at a distal end of the suspension arm 110. The suspension arm 110 comprises a mounting portion 130 connected to the worktable 100, and a swinging portion 140 pivotally connected to the mounting portion 130. The dust collector comprises a suction hole 10 located in the swinging portion 140 of the suspension arm 110, a dust collection unit 20 mounted on the suspension arm 110 and facing toward the suction hole 10, and a binding member 30.

The suction hole 10 is located in one end of the swinging portion 140 of the suspension arm 110 adjacent to the mounting portion 130, defining a bottom opening 11 that faces downwardly tangential to the cutting edge of the saw blade 120 and an upward-facing top opening 12 opposite to the downward-facing bottom opening 11.

The dust collection unit 20 comprises a breathable and flexible dust bag 21, and a rigid support material 22 mounted inside the dust bag 21. The dust bag 21 is made from a breathable fabric.

The dust bag 21 comprises a connecting end 211 detachably fastenable to the top opening 12 by the binding member 30, a bottom end 212 opposite to the connecting end 211, an extending portion 213 connected between the connecting end 211 and the bottom end 212, an inner circumference 214 extending from the connecting end 211 to the bottom end 212, and a sealing member 215 mounted at the bottom end 212. The bottom end 212 is disposed at a relatively lower place than the top opening 12. In this embodiment, the position of the bottom end 212 of the dust bag 21 is also lower than the elevation of the bottom opening 11. Based on the flexible material property of the dust bag 21, the extending length of the extending portion 213 is adjustable. Further, in this embodiment, the sealing member 215 is a zipper, operable to close or open the bottom end 212. In this embodiment, the stretched length of the rigid support material 22 mates with the extended length of the extending portion 213. The rigid support material 22 is a stretchable rigid coil adapted to support the inner circumference 214 in shape, such that when adjusting the extending length of the extending portion 213, the rigid support material 22 is elastically deformed in the extending direction of the extending portion 213.

Referring to FIGS. 3 and 5 again, after installation of the rigid support member 22 of the dust collection unit 20 in the dust bag 21, the connecting end 211 is fastened to the peripheral wall of the top opening 12 of the suction hole 10 with the binding member 30, and the sealing member 215 is operated to close the bottom end 212. During a cutting operation of the saw blade 120, generated dust will fly in the direction tangential to the cutting edge of the saw blade 120 through the suction hole 10 and into the inside of the dust bag 21. The collected dust will then move along the connecting end 211 and extending portion 213 of the dust bag 21 to the bottom end 212. Due to the blocking effect of the sealing member 215, the dust will be accumulated in the bottom end 212. Further, because the inner circumference 214 of the dust bag 21 is stretched open by the rigid support material 22, keeping the bottom end 212 below the elevation of the top opening 12, and keeping the part of the extending portion 213 near the connecting end 211 in a curved condition, will neither make the cross-sectional area of the dust bag 21 smaller nor affect the dust collection performance of the dust bag 21.

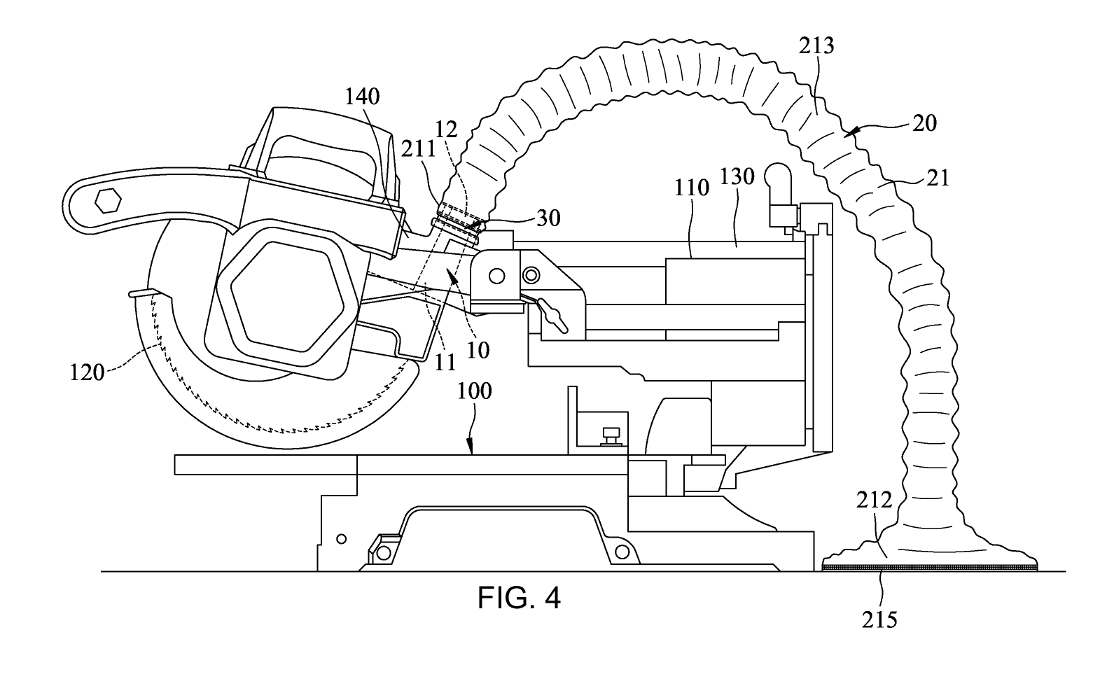

Referring to FIG. 3 and FIG. 4, during the cutting process, the operator can bias the swinging portion 140 of the suspension arm 110 to move the saw blade 120 upwardly relative to the mounting portion 130, and then bias the swinging portion 140 of the suspension arm 110 again to move the saw blade 120 downwardly relative to the mounting portion 130. The dust collected in the bottom end 212 of the dust bag 21 will not be forced to fly backwardly out of the suction hole 10.

After a period of time in use, the operator can open the sealing member 215, and then clean up the dust that has accumulated in the bottom end 212.

Therefore, the invention has many advantages, such as the following:
1. Keeping the position of the bottom end 212 of the dust bag 21 below the elevation of the top opening 12 effectively prevents the collected dust in the bottom end 212 of the dust bag 21 from flying back, thus achieving optimal dust collector performance.
2. The dust bag 21 defines therein a large dust accommodation space, and therefore, it is not necessary to frequently shut down the circular saw and clean up the dust bag during a cutting operation.
3. Subject to the characteristic that the stretched length of the rigid support material 22 can mate with the extended length of the extending portion 213, and the retractable characteristic of the stretchable rigid coil of the rigid support material 22, the position of the bottom end 212 can be freely adjusted to meet different spatial configuration needs. Subject to the retractable characteristic of the rigid support material 22, the application length of the dust collection unit 20 can be freely and conveniently adjusted.

It should further be appreciated that the coil design of the rigid support material 22 does not limit operation of the device. Alternatively, the rigid support material 22 can be composed of a plurality of rigid ring frames (not shown) fastened to the inner circumference 214 of the dust bag 21 and spaced from one another along the length thereof. These rigid ring frames can be variously configured in any of a variety of shapes, not limited to rectangular or circular shapes.

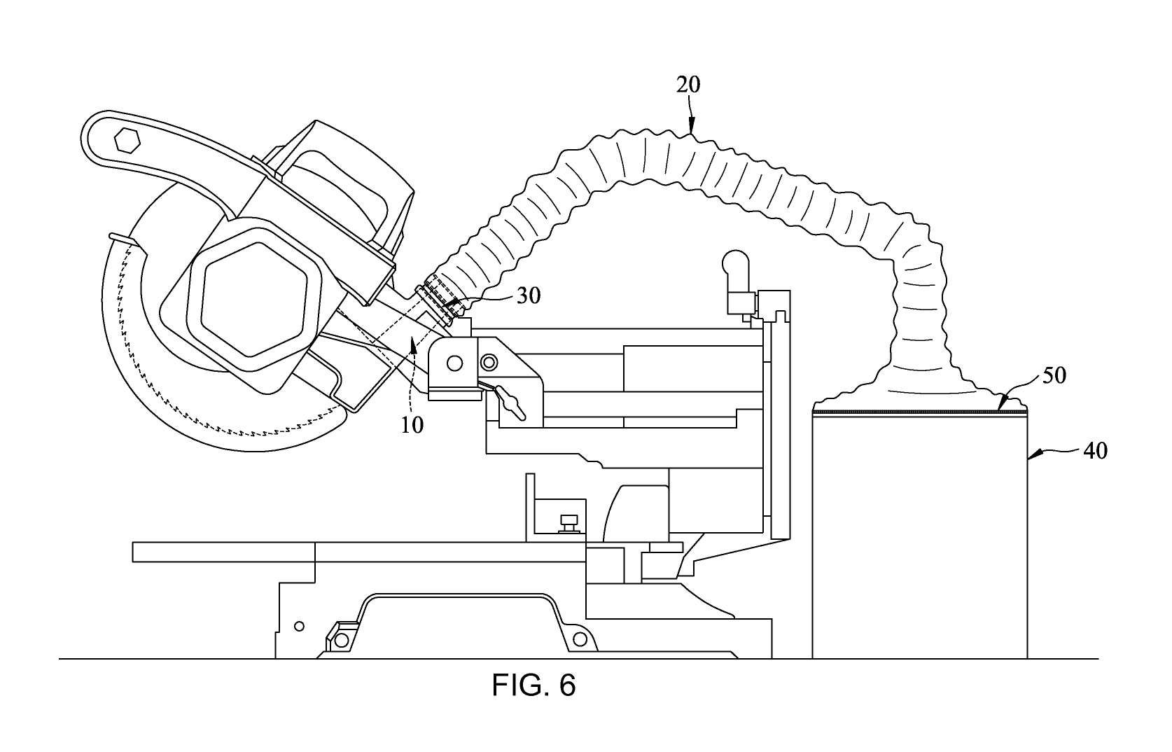

Referring to FIG. 6, a dust collector for circular saw in accordance with a second embodiment of the present invention is shown. In addition to the constituent components of the first embodiment, the dust collector of this second embodiment further comprises a dust container 40 detachably fastenable to the bottom end 212 of the dust bag 21, and a connection device 50 connected between the bottom end 212 of the dust bag 21 and a top end of the dust container 40. In this embodiment, the connection device 50 is a zipper.

The dust container 40 provides a larger space for collecting dust. Further, the dust container 40 has a three-dimensional shape, which facilitates positioning and gives better positionability. Further, the arrangement of the connection device 50 facilitates connection and disconnection between the dust bag 21 and the dust container 40.

In conclusion, the present invention provides a dust collector for a circular saw that has a simple structure and is easy to fabricate and install, and can achieve optimal dust collection performance. Therefore, the dust collector can readily achieve the aforementioned objects of the present invention.

Although particular embodiment of the invention have been described in detail for purposes of illustration, various modifications and enhancements may be made without departing from the spirit and scope of the invention. Accordingly, the invention is not to be limited except as by the appended claims.

What is claimed is:

1. A dust collector, comprising:
a dust bag being elastically collapsible, said dust bag comprising a connecting end, a bottom end opposite to said connecting end, and an elastically deformable extending portion connected between said connecting end and said bottom end.

2. The dust collector as claimed in claim 1, wherein said extending portion of said dust bag is adjustable in length; when said dust bag is disposed in the operating condition, said connecting end is kept to face downward, and said bottom end is disposed below the elevation of said connecting end.

3. The dust collector as claimed in claim 2, wherein said dust bag further comprises an inner circumference extended from said connecting end to said bottom end; said dust collector further comprises a rigid support material mounted in said dust bag to support said inner circumference in shape, said rigid support material being elastically deformable in the extending direction of said extending portion when adjusting the extending length of said extending portion.

4. The dust collector as claimed in claim 3, wherein a stretched length of said rigid support material mates with an extended length of said extending portion; and said rigid support material is a retractable coil.

5. The dust collector as claimed in claim 1, wherein said dust bag further comprises a sealing member mounted at said bottom end and operable to close or open said bottom end.

6. The dust collector as claimed in claim 5, wherein said sealing member of said dust bag is a zipper.

7. The dust collector as claimed in claim 1, further comprising a dust container detachably connected to said bottom end of said dust bag.

8. The dust collector as claimed in claim 7, further comprising a connection device connected between said bottom end of said dust bag and said dust container.

9. The dust collector as claimed in claim 8, wherein said connection device is a zipper.

10. A circular saw, comprising a worktable, a suspension arm disposed above said worktable, a saw blade mounted at said suspension arm, and a dust collector, wherein said dust collector comprises:
a suction hole located in said suspension arm, said suction hole comprising a bottom opening facing downwardly in a tangential manner relative to the cutting edge of said saw blade and an upward-facing top opening opposite to said bottom opening; and
a dust collection unit mounted on said suspension arm to face toward said suction hole, said dust collection unit comprising a flexible dust bag, said dust bag comprising a connecting end fastened to said top opening and an opposing bottom end, said bottom end being disposed below the elevation of said top opening.

11. The circular saw as claimed in claim 10, wherein said dust bag of said dust collection unit further comprises an extending portion connected between said connecting end and said bottom end, said extending portion being adjustable in length.

12. The circular saw as claimed in claim 11, wherein said dust bag of said dust collection unit further comprises an inner circumference extended from said connecting end to said bottom end; and said dust collection unit further comprises a rigid support material mounted in said dust bag and adapted to support said inner circumference in shape, said rigid support material being elastically deformable in the extending direction of said extending portion when adjusting the extending length of said extending portion.

13. The circular saw as claimed in claim 12, wherein the stretched length of said rigid support material mates with the extended length of said extending portion; and
said rigid support material is a retractable coil.

14. The circular saw as claimed in claim 10, wherein said dust bag of said dust collection unit further comprises a sealing member mounted at said bottom end and operable to close or open said bottom end.

15. The circular saw as claimed in claim 14, wherein said sealing member of said dust bag is a zipper.

16. The circular saw as claimed in claim 10, wherein said dust collection unit further comprises a dust container detachably connected to said bottom end of said dust bag.

17. The circular saw as claimed in claim 16, wherein said dust collection unit further comprises a connection device connected between said bottom end of said dust bag and said dust container.

18. The circular saw as claimed in claim 17, wherein said connection device of said dust collection unit is a zipper.

19. The circular saw as claimed in claim 10, wherein said bottom end of said dust bag of said dust collection unit is disposed below the elevation of said bottom opening.
